(19) United States
(12) Patent Application Publication
(10) Pub. No.: US 2009/0024726 A1
(43) Pub. Date: Jan. 22, 2009

(54) DEVICE FOR NETWORK SYSTEM AND METHOD OF TRANSMITTING PROFILE

(75) Inventors: Woong Jeon, Seoul (KR); Jong Hoon Chung, Gyeonggi-do (KR); Sang Kyun Lee, Seoul (KR); Koon Seok Lee, Kyungsang-namdo (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/885,014

(22) PCT Filed: Feb. 23, 2006
(86) PCT No.: PCT/KR06/00630

§ 371 Date: Sep. 25, 2008

(30) Foreign Application Priority Data
Feb. 24, 2005 (KR) 10-2005-0015572

(51) Int. Cl. G06F 15/173

(52) U.S. Cl. 709/223

(57) ABSTRACT

The present invention relates to a device for a network system and a method of transmitting a profile in a network system. The method provides a user with convenience in remote control and monitoring operation of appliances. By this method, a user, for example, who is locating at home or out-of-home, can control the operation or monitor the operational state of various appliances such as refrigerator or laundry machine through a living network installed at home, such as RS-485 network, a low power RF network, or a power line network. The method according to the present invention further provides a user with effective network service by continuously managing and updating information on all devices constituting the network using a network profile.

This application is a National Stage entry of PCT Application No. PCT/KR2006/000630, filed Feb. 23, 2006, and claims the benefit of Korean Application No. KR 10-2005-0015572, filed Feb. 24, 2005, each of which are incorporated herein by reference in their entireties.

### BACKGROUND

1. Field of the Disclosure

The present invention relates to a device for a network system and a method of transmitting a profile in a network system, by which a user, for example, who is locating at home or out-of-home can effectively control household appliances such as refrigerator or laundry machine connected to a living network.

2. Discussion of the Related Art

In general, ‘home network’ means a network in which various digital appliances are connected to one another for the user to enjoy economical home services in a convenient and safe way anytime at home or out-of-home, and due to the development of digital signal processing technology, various types of appliances such as refrigerator or laundry machine are being gradually digitalized.

On the other hand, in recent years, home network has been more advanced, since operating system and multi-media technology for appliances has been applied to digital appliances, as well as new types of information appliances have appeared.

Moreover, in a general meaning, a network which is established for providing file exchanges or internet services between personal computers and peripheral devices, a network between appliances for handling audio or video information, and a network established for home automation of various appliances such as refrigerator or laundry machine, appliance control such as remote meter reading, and the like are called a ‘living network’.

Furthermore, in the network services in which small-scale data transmission for the remote control, or operating state monitoring of the appliances included in the network, for example, various appliances such as refrigerator or laundry machine, is the main object of their communication, each of appliances connected to one another should be directly controlled by a network manager, which is included in the living network, with the use of the minimum required communication resources. However, its effective solution has not been provided yet, and thus it is a matter of urgency to provide its solution.

### SUMMARY

Accordingly, the present invention is devised in consideration of the aforementioned situation, and it is an object of the invention to provide a device for a network system and a method for transmitting a profile in a network system, by which a user, for example, who is locating at home or out-of-home can effectively control various appliances such as refrigerator or laundry machine connected to a network by using the minimum required communication resources and can effectively manage information of all devices constituting the living network using a network profile.

In order to achieve the aforementioned object, there is provided a device for a network system, the device being connectable to a network and having a network manager which has a network profile comprising profiles of respective devices connected to a network, wherein the profile of each device includes one or more ones elected from the group consisting of a device information file, a node parameter file, a device operation information file.

In order to achieve the aforementioned object, there is provided a method of transmitting a network profile in a network system, comprising a first step of producing and storing a network profile including profiles of devices connected to a network in which the producing and storing is performed by a network manager, and a second step of transmitting an updated network profile when the produced and stored network profile is updated.

### BRIEF DESCRIPTION OF THE DRAWINGS

The above and other objects, features and advantages of the present invention will become apparent from the following description of preferred embodiments given in conjunction with the accompanying drawings, in which:

FIG. 1 illustrates the structure of a network system according to the present invention;

FIG. 2 and FIG. 3 illustrate the master-to-slave based communication structure applied to the present invention;

FIG. 4 illustrates a hierarchy of an LnCP network applied to the present invention;

FIGS. 5 to 7 illustrate examples of communication cycle services applied to the present invention;

FIG. 8 illustrates a hierarchy of an LnCP protocol according to the present invention;

FIG. 9 illustrates an example of a primitive for interfacing a network management sublevel with a parameter management level according to the present invention;

FIG. 10 illustrates an example of the structure of interface between levels according to the present invention;

FIG. 11 illustrates a method of managing a network profile by a network manager according to one embodiment of the present invention;

FIG. 12 illustrates an example of a network profile according to the embodiment of the present invention;

FIG. 13 illustrates an example of a device information file according to the embodiment of the present invention;

FIG. 14 illustrates an example of a device node parameter file according to the embodiment of the present invention;

FIG. 15 illustrates an example of a device operation information file according to the embodiment of the present invention;

FIG. 16 illustrates an example of a scenario file according to the embodiment of the present invention.

### DETAILED DESCRIPTION OF THE INVENTION

Hereinafter, a device for a network system and a method of transmitting a profile in a network system, according to one embodiment of the present invention will be described with reference to the accompanying drawings.

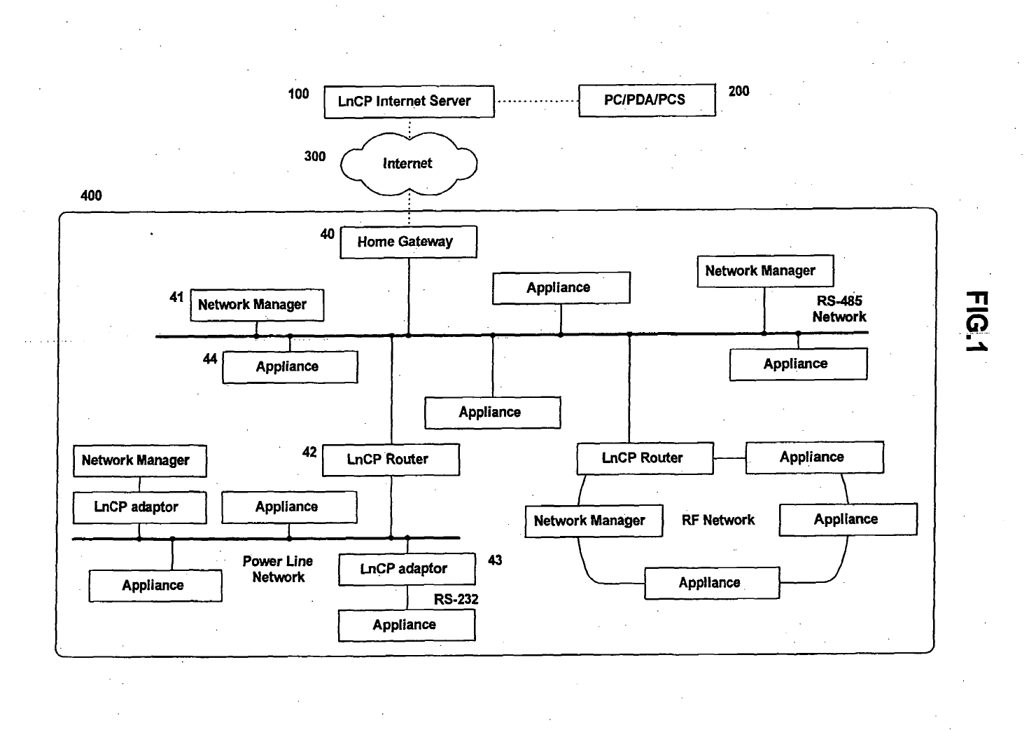

FIG. 1 illustrates the structure of a network system for use in the present invention. An LnCP internet server 100 to which a living network control protocol (LnCP) which is newly defined in this invention is applied and the living network control system 400 are connected to each other through the internet 300. The LnCP internet server 100 performs interface operations between a variety of kinds of communication terminals 200, such as a personal computer (PC), a personal digital assistant (PDA), or a personal communication service (PCS).

The living network control system 400 comprises a home gateway 40, a network manager 41, an LnCP router 42, an LnCP adaptor 43, and appliances 44. As shown in FIG. 1, the components of the living network control system 400 use a non-standard transmission medium having a non-standard data link layer, such as RS-485 network or a low level output RF network, or use a standard transmission medium having a standard data link layer, such as a power line communication, IEEE 802.11 or ZigBee (IEEE 802, 15.4).

The living network control system 400 is called, for example, “LnCP network.” As shown in FIG. 1, the LnCP network is an independent network that connects home appliances belonging to the living network category by wire or wireless media.

The LnCP network is connected to a master device which controls the operation of appliances or monitors the operation status of the appliances, and to a slave device having a response function for responding to a request of the master device and an informing function for informing status change of itself. As shown in FIG. 1, the environment setting and management function of appliances 44 connected to the LnCP network is charged by the network manager 41. The appliances 44 can be directly connected to the network or indirectly connected to the network via an LnCP adaptor 43. The RS-485 network, the RF network, and the powerline network in the LnCP network are connected via the LnCP routers 42.

The LnCP network provides a user with a function that the user residing away from a user's home can check the operation status of appliances or control the appliances installed in the user's, using the internet 300. In this instance, the connection between the LnCP network and the internet 300 are made via a home gateway 40. In order to access the LnCP network, the user accesses the LnCP internet server 100 first and goes through the authentification process. After the authentification process is successful, the user can monitor the operation status of the appliances or control the operation of the appliances connected to the LnCP network.

Further, the user can download contents provided by the LnCP internet server 100 by accessing the LnCP internet server 100 through the home gateway 40 provided in the appliances connected to the LnCP network. In this instance, the LnCP network has the following features in order to facilitate the above described function.

Digital information appliances have a micro controller of a variety of levels performances to perform the intrinsic functions thereof. In the LnCP network, the digital information appliances have the simplest function so that they can operate in the micro controllers having the variety of levels of performances, thereby using the least resource of the micro controller mounted in the appliances. In particular, the micro controller having a low level performance is designed to be able to perform the LnCP communication function as well as to perform the intrinsic functions of the appliances, and the micro controller having a high level performance is designed to be able to support a multi-tasking function.

The main features of the LnCP network according to the present invention include a master-slave based communication structure, event-driven communication support, plural network manager support, 4-layer structure, communication cycle service, and versatility in address management, variable-length packet communication and provision of standard message set.

The master-slave based communication structure is used as a communication structure between appliances in the LnCP network, and comprises at least one master device. The master device must have information of slave devices to be controlled and have control codes. The master device controls slave devices by receiving inputs from a user or by according to previously input programs.

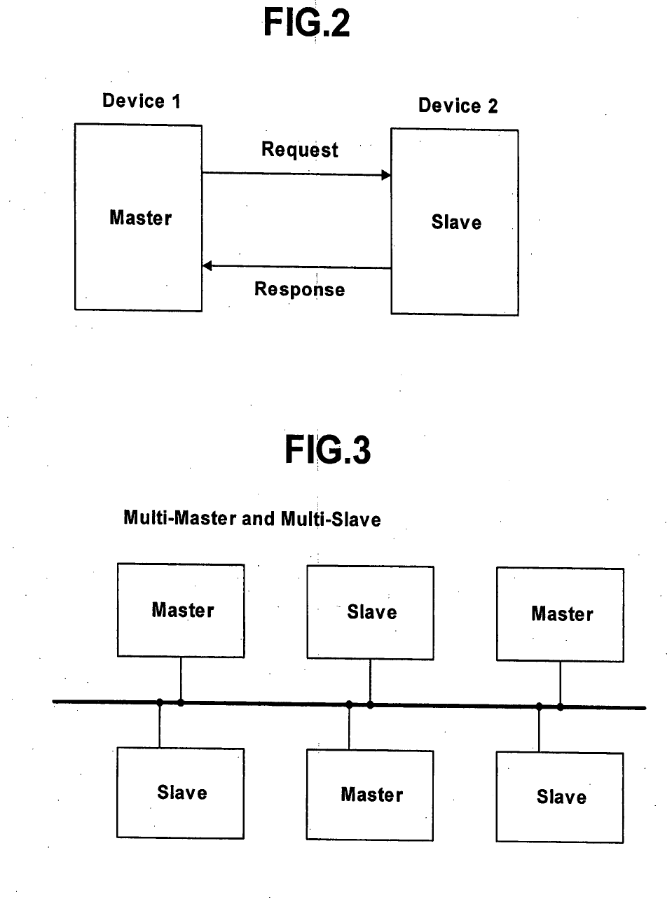

For example, as shown in FIG. 2, message flow between the master device and the slave devices is as follows: If the master device sends a request message to a slave device, the slave device sends a response message to the master device. As shown in FIG. 3, the LnCP network can have multi-master and multi-slave based communication structure.

The LnCP network supports an event-driven communication service. That is, a user can set an event needed by a user for an appliance, and the corresponding appliance informs other appliances of occurrence or content of the event when the event set by the user occurs, or controls the operation status of the other appliances, according to the event.

The LnCP network includes one or more network managers having a function to set or manage environment of appliances, particularly can support a plurality of network managers if necessary. In this case, management information of appliances should be synchronized, in order to make preparation for errors of the network managers.

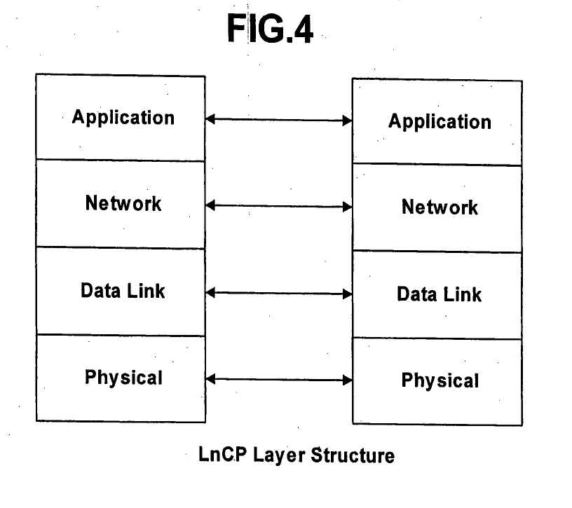

As shown in FIG. 4, the LnCP network has four application layers, including a physical layer, a data link layer, a network layer and an application layer. The LnCP network provides a service in the unit of communication cycles, and the slave device has only one communication cycle at the given time point.

That is, the slave device is not controlled by any master device during the own communication cycle of the slave device. However, the master device has a plurality of communication cycles at the given time point, wherein there are four kinds of communication cycles, including {1-request, 1-response}, {1-request, 1-multi-response}, {1-notification}, and {repeated-notification}.

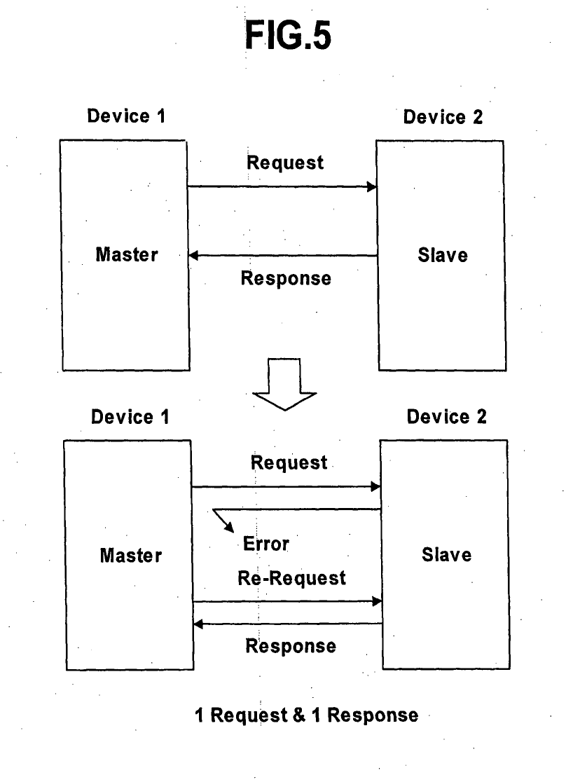

For example, the {1-request, 1-response} communication cycle is a cycle in which one master device sends one request packet to one slave device, and the slave device transmits one response packet in response to the request from the master device. At this time, if an error is caused to the received packet, as shown in FIG. 5, the master device sends a re-request packet and the slave device transmits a response packet in response to the re-request.

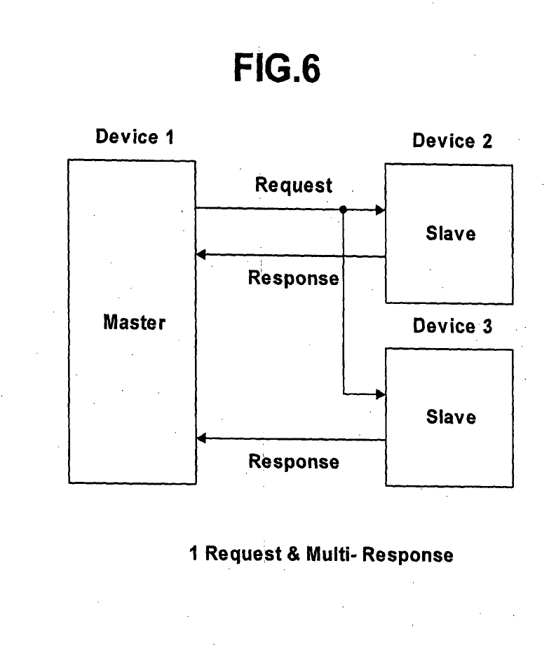

The {1-request, multi-response} communication cycle as shown in FIG. 6 is a cycle in which a maser device sends a request packet having a group address to a plurality of slave devices, and each of the slave devices transmits a response packet to the master device in response to the request packet. By the way, in the master device, the cycles are finished after a lapse of the allowed maximum reception time. After finish of the cycles, the master device neglects errors in the received response packet from the slave devices.

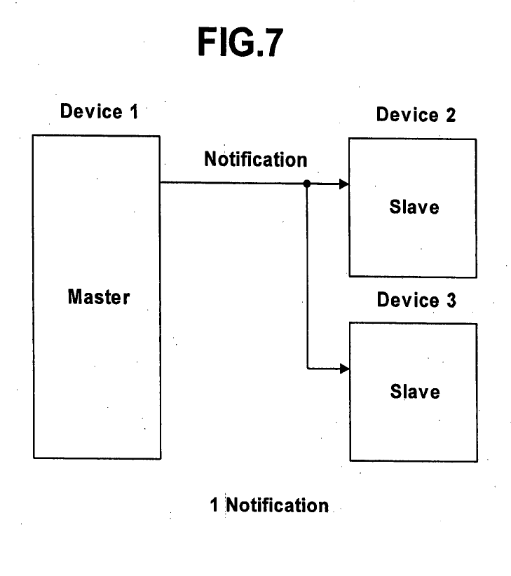

The {1-notification} communication cycle as shown in FIG. 7 is a cycle in which a master device finishes a cycle right after sending a notification packet to one or more devices. The {repeated-notification} communication cycle is a cycle in which the master device finishes communication after repeatedly sending the same packet in order to ensure the transmission reliability in the {1-notification} cycle.

The LnCP network supports a versatile address management. For example, since appliances having the LnCP function are assigned with addresses based their types at the shipment from a factory, they can automatically constitute a network without any intervention of the user. At this time, since the appliances of the same type are initialized with the same address, the network manager has an algorithm that allocates an intrinsic address to each of the appliances when the appliances are connected.

Since the LnCP network allocates an intrinsic group address to the appliances belonging to the same group, the group communication can be performed by using one message. Further, the LnCP network can classify a plurality of kinds of appliances into clusters, and allocate a group address to each cluster.

The LnCP network supports the variable-length packet communication. For example, when downloads contents, such as application programs for controlling appliances, or uploads data stored in appliances, length of packet is adjusted based on buffer size provided in appliances.

Further, the LnCP network provides the standard message set. For example, the standard message set, which is proper for various appliances, is defined for each application layer so that the master devices can control other appliances. The message set comprises a common area message set for basic LnCP communication, an application area message set for supporting intrinsic functions of appliances, and a developer area message set for supporting intrinsic functions provided by a manufacturer.

The message sets can be broadened if necessary, and factors in the pre-defined message can be added. Hereinafter, a hierarchy which is the main feature of the LnCP network according to the present invention will be described in more detail.

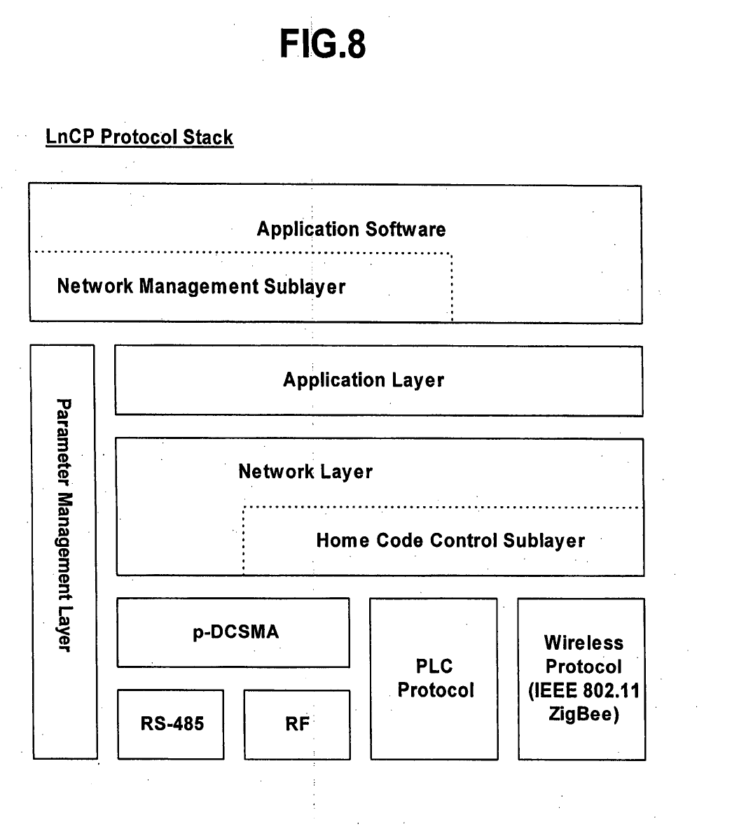

FIG. 8 illustrates the hierarchy of the LnCP protocol used in the LnCP network. As described above, the hierarchy of the LnCP network comprises four layers, including a physical layer for controlling and monitoring the operation of appliances, such as refrigerator or washing machine, a data link layer, a network layer and an application layer.

The physical layer provides a physical interface function between devices and a transmission and reception function of physical signals such as bits. Example of the physical layer includes a non-standard transmission medium, such as RS-485 and low level output RF, which has a non-standard data link layer, and a standard transmission medium, such as power line, Ethernet, IEEE 802.11, and ZigBee, which has a standard data link layer. In the LnCP network, an LnCP adaptor can be used in order to implement a physical layer of devices.

The data line layer provides a medium access control (MAC) function for using common transmission medium. In the case of using the non-standard transmission medium having a non-standard data link layer in the LnCP network, probabilistic delayed carrier sense multiple access (p-DCSMA) is needed to be used as the medium access control (MAC) protocol.

However, in the case of using the standard transmission medium having the standard data link layer in the LnCP network, the MAC function defined by the corresponding protocol can be used.

Referring to FIG. 8, a home code control sublayer provides home code setting, management and processing functions for logically identifying individual networks, when the LnCP network is constituted by using the dependent transmission medium, such as power line, IEEE 802.11, ZigBee, low level output RF. The home code control sublayer is not preferably implemented in the case in which the individual network is physically separated by the independent transmission medium, such as RS-485.

The network layer provides an address management function of appliances and a transmission and reception control function for reliable network connection between devices. The application layer provides a transmission and reception control function for performing services of application soft wares and a flow control function for download and upload service.

The application layer also defines a message set for controlling and monitoring appliances and for managing a network, and the application softwares perform intrinsic functions of the appliances and exchange with the application layer data via an interface defined in the application layer.

Further, as shown in FIG. 8, the network management sublayer provides a parameter management function for setting node parameters and a network management function for configuring and managing a network. The parameter management layer can set or read parameters used in each layer for accommodating demand of the network management sublayer.

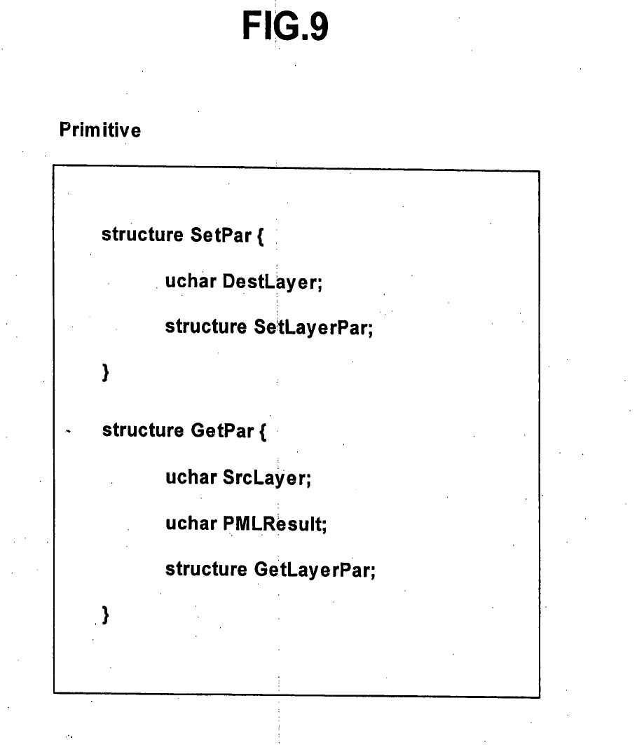

Referring to FIG. 9, the primitive for interfacing with the network management sublayer comprises a primitive “structure SetPar” for transferring a value of a parameter from the network management sublayer to a parameter management layer, and a primitive “structure GetPar” for transferring a value of a parameter from the parameter management layer to the network management sublayer.

On the other hand, the primitive “structure SetPar” for transferring the parameter value to the parameter management layer includes therein “uchar DestLayer” which is a layer to transfer the parameter value, and “structure SetLayerPart” which is a variable varying according to a value of the DestLayer. The value of the DestLayer is set to “1” when the layer to transfer the parameter value is an application layer, “2” when the layer to transfer the parameter value is a network layer, and “3” when the layer to transfer the parameter value is a data link layer, and “4” when the layer to transfer the parameter value is a physical layer.

The variable SetLayerPart is set to “SetALPar” when the layer to transfer the parameter value is the application layer, “SetNLPar” when the layer to transfer the parameter value is the network layer, and “SetDLLPar” when the layer to transfer the parameter value is the data link layer, and “SetPHYPar” when the layer to transfer the parameter value is the physical layer.

On the other hand, the primitive “structure GetPart” for transferring the parameter value to the network management sublayer, includes therein “uchar SrcLayer,” a layer which transmitted the parameter value, “uchar PMLResult,” which indicates if the parameter value is successfully obtained from each layer, and “structure GetLayerPart” which is a parameter for each layer and varies according to the value of the SrcLayer. The value of the SrcLayer is set to “1” when the layer which transmitted the parameter value is the application layer, “2” when the layer which transmitted the parameter value is the network layer, “3” when the layer which transmitted the parameter value is the data link layer, and “4” when the layer which transmitted the parameter value is the physical layer.

Further, in the case in which the parameter value is successfully obtained from each value, the PMLResult is wet to PAR_OK(1). If not, the PMLResult is set to PAR_FAILD(0). Still further, the GetLayerPar is set to “RptALPar” for the application layer, “RptNLPar” for the network layer, “RptDLLPar” for the data link layer, and “RptPHYPar” for the physical layer.

There is a parameter “const unit ParTimeOut” used in the parameter management layer. The parameter “const unit ParTimeOut” is a standby time (ms) for waiting for receiving RptALPar, RptNLPar, RptDLLPar or RptPHYPar after transmission of GetALPar, GetNLPar, GetDLLPar or GetPHYPar to each layer.

The parameter management layer transfers SetALPar, SetNLPar, SetDLLPar or SetPHYPar to the layer noted in the primitive when it receives the SetPar primitive from the network management sublayer. Further, in the case in which a value of all of bits of the received primitive is “1,” the variable is neglected (For example: OXFF, OXFFF).

On the other hand, when the parameter management layer receives the GetPar primitive from the network management sublayer, the parameter management layer transfers GetALPar, GetNLPar, GetDLLPar or GetPHYPar to the layer noted in the primitive. If the parameter management layer receives the RptALPar, RptNLPar, RptDLLPar or RptPHYPar from each layer, the parameter management layer transfers the GetPar primitive and PARResult which is set to PAR_OK to the network management sublayer. However, if the parameter management layer does not receive the primitive from each layer in the time ParTimeout, the PARResult which is set to PAR_FAILD is transferred to the network management sublayer.

The network management sublayer provides a parameter management function for helping node parameter setting of individual devices, a network configuration function, an environment setting function, and a network operation management function. If there is a request from application softwares or a master device, the network management sublayer sets or reads the parameter value via the parameter management layer.

For example, the network management sublayer sets or reads the parameter values of AddressResult, NP_Alivelnt, SvcTimeOut, and NP_BufferSize for the application layer, the parameter values of NP_LogicalAddress, NP_ClusterCode, NP_HomeCode and SendRetries for the network layer, the parameter value of MinPktInterval for the data link layer, and the parameter value of NP-bps for the physical layer.

In particular, the network management sublayer of slave devices sets or reads a value of a parameter to or from the corresponding layer through the parameter management layer when it receives the UserReqRcv primitive including application services belonging to a device node parameter setting service or a device node parameter acquisition service, and then transfers the result to the application layer through the UserResSend primitive. The application services for managing the parameter for each layer are as follows:

For example, application services for the application layer include SetOption service, SetAliveTime service, SetClock service, and GetBufferSize service; application services for the network layer include SetTempAddress service, SetAddress service, and GetAddress service; and application services for the physical layer include SetSpeed service. There is no application service for the data link layer.

On the other hand, the network management sublayer provides an LnCP network configuration function, an environment setting function, and a network management function for managing operation of network. General network management function is operated on the application layer of a master device, and some functions such as a network information synchronization function are operated on the application layers of slave devices in some network management periods.

The interface with the application layer includes an interface with an application layer of a slave device and an interface with an application layer of a master device. The interface with the application layer of the slave device uses UserReqRcv and UserResSend primitives. The interface with the application layer of the master device uses UserReq, UserDLReq, UserULReq, UserRes, UserEventRcv and ALCompleted primitives.

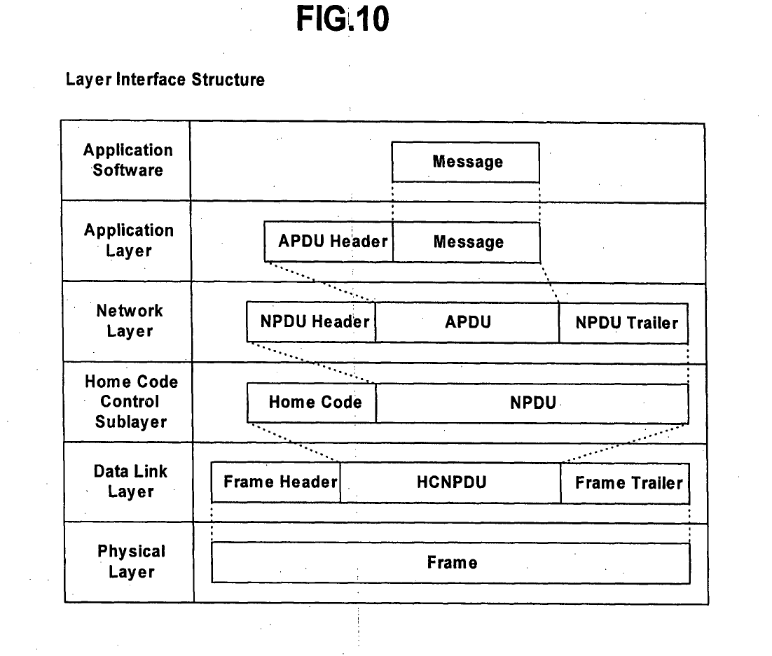

As shown in FIG. 10, the interfacing method in the living network control system according to the present invention adds a header and a trailer required by each layer to a protocol data unit (PDU) received from the corresponding upper layer and transfers the combination of the PDU, the heater and the trailer to the corresponding lower layer.

For example, an application layer PDU (APDU) is a packet exchanged between the application layer and the network layer, and comprises an APDU header and a message. A network PDU (NPDU) is a packet exchanged between the network layer and the data link layer or the home code control sublayer, and comprises an address of APDU, an address of itself, an address of a target appliance, an NPDU header, such as a packet type classified by importance degree of a message to be transmitted, an NPDU trailer, an APDU.

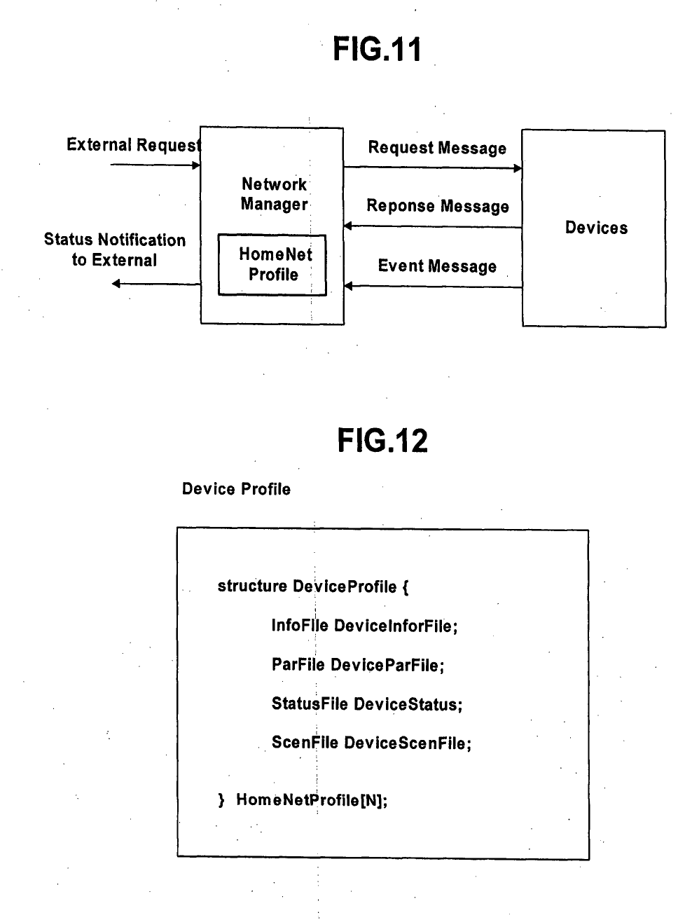

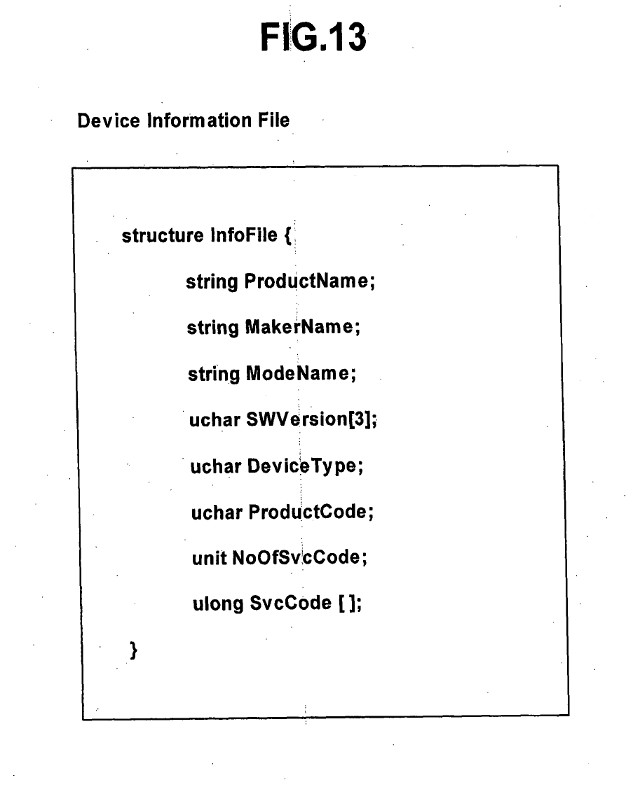

Further, as shown in FIG. 11, the network manager according to the present invention continuously manages information of all devices constituting the LnCP network using a network profile. The network profile can be named as homenet profile (HomeNet Profile) as shown in FIG. 11. The network manager continuously manages the homenet profile and provides a network service to a user.

The network manager performs a network configuration for setting operation environment of all devices connected to the LnCP network, and updates the home net profile by the communication result between normal devices after completion of the network configuration.

As shown in FIG. 11, the network configuration is performed when a network configuration message is transferred from the outside of the network manager or devices after a power is applied to the appliances and the network manager in the LnCP network.

After the network configuration is completed, the network manger performs general operations to manage events occurring in devices or occurring during user's control. At this time, the home net profile comprises device profiles with information on individual devices whose network manger is connected to the network.

As shown in FIG. 12, the device profile includes therein a device information file “InfoFile DeviceInforFile” having information of each device, which is stored in the network manager, a node parameter file “ParFile DeviceParFile,” a device operation file “StatusFile DeviceStatus,” a scenario file “ScenFile DeviceScenFile,” and the number of devices “Home net Prifile[N]” recorded in the network manager.

The device information file is stored in a non-volatile memory of a slave device as data having device inherent information which is held by individual slave devices connected to the network, and comprises a device name “ProductName”, a device manufacturer name “MakerName”, a device model name “ModelName”, a software version containing year, month and date “SWVersion[3]”, a device type “DeviceType”, a product code “ProductCode”, the number of service codes “No0fSvcCode” which are implemented, and a service code “SvcCode” which is implemented. The device type “DeviceType” is set to “1” for a network manager, and “2” for a hybrid, and “3” for a slave device.

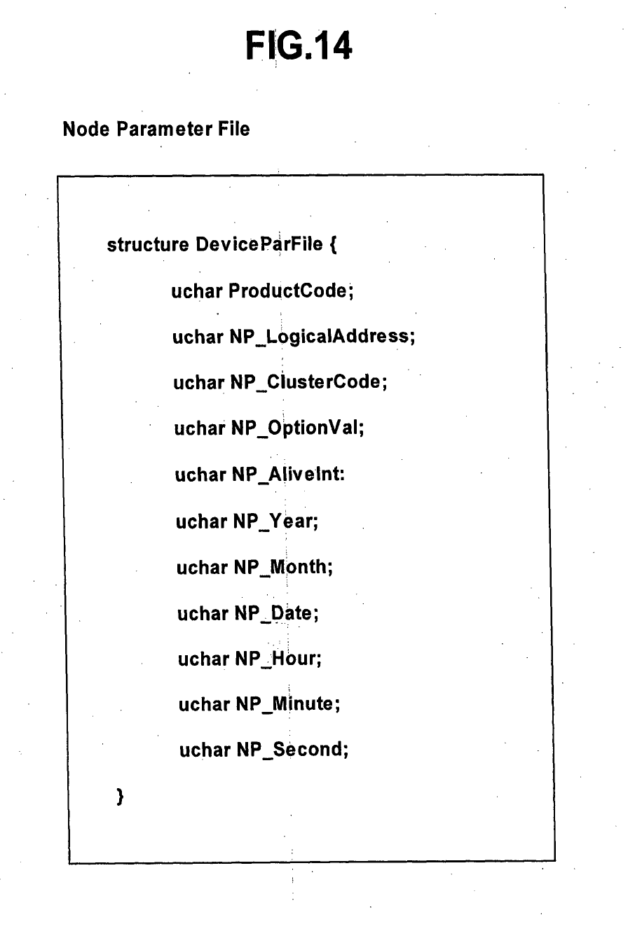

The node parameter file is stored in a nonvolatile memory of a slave device as data having a node parameter set in individual slave devices by the network configuration. As shown in FIG. 14, the node parameter file includes a produce code “ProductCode”, a logical address “NP-LoggicalAddress”, a cluster code “NP_ClusterCode”, an option value “NP_OptionVal”, an communication buffer size “NP_BufferSize” for the APDU in the application layer, an informing interval “NP_AliveInt”, and an informing time (Year/Month/Day/Hour/Minute/Second).

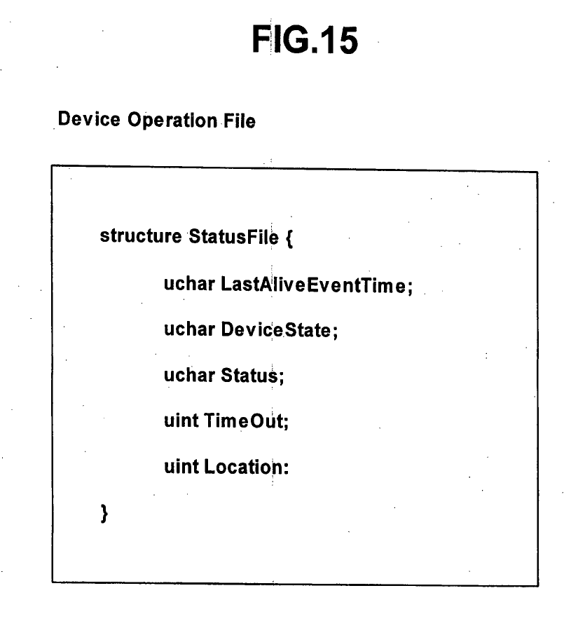

The device operation information file is data indicating device operation status and stored in a nonvolatile memory of the network manager. As shown in FIG. 15, the device operation information file includes a latest message reception time “LastAliveEventTime” at which the latest AliveEvent message is received, device on/off-line state “DeviceState”, device detail status information “Status” which is detailed state information of a device which is on on-state, a standby time “TimeOut” which is a time that a master waits a response packet after transmitting a request packet in the case of unicast, and a code value “Location” which indicates an installation place of a device. The device detail state information “Status” is set to the value “0” when the device is on standby, “1” when the device is operated, “2” when the device is on temporarily stopped, and “2” when the device is in error.

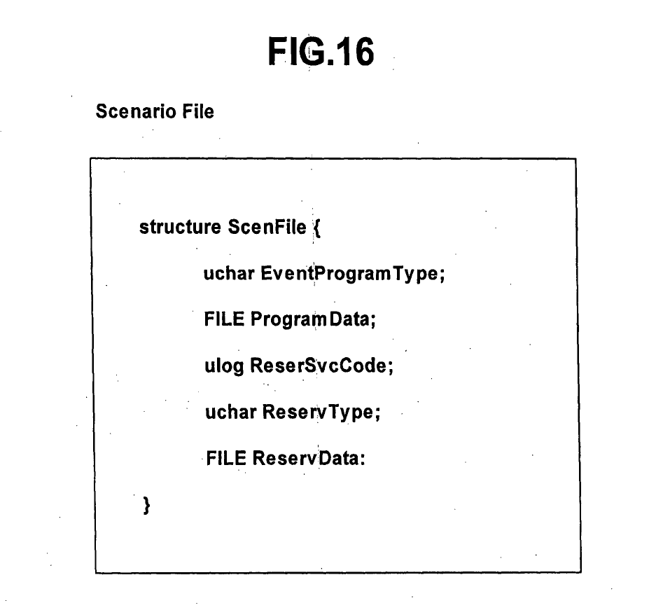

The scenario file is data to define value added service for each individual device connected to the network, and includes an event program and a reserved schedule. The scenario file is stored in a nonvolatile memory of a network manager. As shown in FIG. 16, a type of event program “EventProgamType”, program data “ProgramData”, a service code for operation reservation “ReserSvcCode”, a type of reservation operation “ReserveType” and reservation data “ReservData”.

For example, the type of event program EventProgramType is set to the value “0” when an event program is stored in a network manager, and the type of event program EventProgramType is set to the value “1” when the event program is stored in each device. The reservation service code ReserSvcCode is set to OxOOOOOOOO in the case in which there is no service code, and the type of reservation operation is set to “0” when the type is temporary and is set to “1” when the type has consistency.

The home net profile can be updated in the case in which the network configuration is completed by using a network management service, changes in device operation environment and status are found after communication with normal devices by an appliance control service and an appliance product status management service, it is detected that an event occurrence informing service is used, or another network manager requests the update of the homenet profile by using a network data synchronization service.

When the new network configuration is completed, since changed content of the home net profile is informed by using the application service belonging to data base synchronization service of the network managers, the home net profile being stored and managed by other network managers are updated.

The device for a network system and a method for transmitting a profile in a network system according to the present invention which is constructed as described above can provide a user with convenience in remote control and monitoring, and provides a user with an effective network service by continuously managing information of all devices.

As describe above, while the present invention has been disclosed for the purpose of illustration with reference to the aforementioned preferred embodiment, more various appliances can be connected to a living network according to the present invention, the living network and the homenet profiled can be called other names, and it will be understood by those skilled in the art that the foregoing embodiment can be improved, modified, substituted or added in a variety of ways without departing from the technical spirit and scope of the invention as defined by the appended claims.

What is claimed is:

1. A device for a network system, the device being connectable to a network and including a network manager, in which the network manager has a network profile comprising profiles of respective devices connected to a network, and each of the profiles of the respective devices comprises one or more ones selected from the group consisting of a device information file, a node parameter file, and a device operation information file.

2. The device as clamed in claim 1, wherein the network profile further comprises information on the numbers of devices registered in a network manager.

3. The device according to claim 1, wherein the network profile is updated based on a result of network configuration for setting operational environment of all devices connected to a network and based on a communication result with devices.

4. The device as claimed in claim 1, wherein the device information file is data including device intrinsic information held by individual slave devices connected to a network.

5. The device as claimed in claim 1, wherein the device information file comprises one or more ones selected from the group consisting of device name, device manufacturer, device mode name, software version including year, month and day, device type, product code, the number of service codes which are implemented, service codes which are implemented.

6. The device as claimed in claim 5, wherein the device type is set to 1 for a network manager, 2 for a hybrid, and 3 for a slave device.

7. The device as claimed in claim 1, wherein the node parameter file is data containing a node parameter set in individual slave devices by the network configuration, and is stored in a nonvolatile memory of the slave devices.

8. The device as claimed in claim 1, wherein the node parameter file includes one or more selected from the group consisting of product code, logical address, cluster code, option value, communication buffer size in an application layer, informing interval, a time of year/month/day/hour/minute/second.

9. The device as claimed in claim 1, wherein the device operation information file is data indicating operation status of devices, and is stored in a nonvolatile memory of the network manager.

10. The device as claimed in claim 1, wherein the device operation information file includes one or more selected from the group consisting of latest event message reception time, device on/off-line state, device detail status information of when the devices are on state, packet standby time for waiting a respond packet after packet transmission by a master device, and a code value indicating device installation place.

11. The device as claimed in claim 10, wherein the device detail status information is set to 0 when the device is on standby, 1 when the device is operated, 2 when the device is temporally stopped and 3 when the device in error.

12. The device as claimed in claim 1, wherein content of the network file is updated in one or more cases selected from the group consisting the cases in which configuration of a network is completed using a network management service, any changes of device operation environment and device status are detected by communication with normal devices using appliance control service and appliance status management service, use of event occurrence informing service is detected, and another network manager requests update of the home net profile using network data synchronization service.

13. A method of transmitting a network profile in a network control system, comprising:
a first step of producing and storing a network profile including profiles of respective devices connected to a network in which the producing and storing is performed by a network manager; and
a second step of transmitting an updated network profile when the stored network profile is updated to different network managers.

14. The method as claimed in claim 13, after the completion of the network configuration, wherein a network profile of a different network manager is updated by informing contents of the changed network profile to the different network manger using an application service belonging to a data base synchronization service of the network managers.

15. A method of transmitting a network profile in a network control system comprising:
creating and storing a network profile being comprised of profiles of devices connected to a network; and
transmitting an updated network profile to a different network manager when the stored network profile is updated.

16. The method as claimed in claim 15, further comprising a step of updating the network profile stored in and managed by the different network managers when the different network managers receive the updated network profile.

17. The method as claimed in claim 15, wherein the device profile includes one or more ones selected from the group consisting of a device information file, a node parameter file and a device operational information file.

18. The method as claimed in claim 15, wherein the updated network profile is transferred to different network managers using an application service that synchronizes database between network managers.
